(19) United States
(12) Patent Application Publication
(10) Pub. No.: US 2026/0281891 A1
(43) Pub. Date: Sep. 17, 2026

(54) WIRELESS ACCESS POINT AND ENERGY SAVING CONTROL METHOD THEREOF

(71) Applicant: ASUSTeK COMPUTER INC., Taipei City (TW)

(72) Inventors: Jen-Hsiao Wen, Taipei City (TW); Hao-Yu Cheng, Taipei City (TW)

(73) Assignee: ASUSTeK COMPUTER INC., Taipei City (TW)

(21) Appl. No.: 19/198,163

(22) Filed: May 5, 2025

(30) Foreign Application Priority Data
Mar. 14, 2025 (TW) 114109473

(51) Int. Cl. H04W 52/02; H04W 76/10; H04W 80/02

(52) U.S. Cl. CPC H04W 52/0206; H04W 76/10; H04W 80/02

(57) ABSTRACT

Provided are a wireless access point and an energy saving control method thereof. The wireless access point includes a main system and a low power consumption wireless module. The main system includes a storage media, a processor and multiple functional members. The storage media stores a user list. The processor turns on the low power consumption wireless module and transmits a beacon packet to the low power consumption wireless module in response to receiving a sleep request in a working mode. The low power consumption wireless module turns off the functional members in response to receiving the beacon packet to allow the wireless access point to enter a sleep mode. The low power consumption wireless module sends the beacon packet during the sleep mode, and turns on the functional members in response to receiving a probe request to allow the wireless access point to return to the working mode.

### CROSS-REFERENCE TO RELATED APPLICATION

This application claims the priority benefit of Taiwan application serial no. 114109473, filed on Mar. 14, 2025. The entirety of the above-mentioned patent application is hereby incorporated by reference herein and made a part of this specification.

### BACKGROUND

### Technical Field

The disclosure relates to a wireless access point (wireless AP), and in particular relates to a wireless access point and an energy saving control method thereof.

### Related Art

Generally, in order to maintain normal operation of the network, a wireless access point serving as a basic network equipment usually does not enter a sleep mode. Users may only disable some functions of the wireless access point through software (such as turning off the display function) to reduce the power consumption of the wireless access point. However, disabling some functions through software is not only operationally complex, but the power consumption that may be reduced is also very limited.

### SUMMARY

The disclosure provides a wireless access point and an energy saving control method thereof, which can significantly enhance an energy saving effect of the wireless access point and simplify a sleep and wake-up process of the wireless access point.

The disclosure provides a wireless access point. The wireless access point includes a main system and a low power consumption wireless module. The low power consumption wireless module is coupled to the main system. The main system includes a storage media, a processor, and multiple functional members. The storage media stores a user list. The processor is coupled to the storage media. The multiple functional members are electrically connected to the processor. The processor turns on the low power consumption wireless module and transmits a beacon packet to the low power consumption wireless module in response to receiving a sleep request in a working mode. The low power consumption wireless module turns off the functional members in response to receiving the beacon packet to allow the wireless access point to enter a sleep mode. The low power consumption wireless module sends the beacon packet during the sleep mode. The low power consumption wireless module turns on the functional members in response to receiving a probe request to allow the wireless access point to return to the working mode.

The disclosure also provides a wireless access point. The wireless access point includes a main system, a control circuit, and a low power consumption wireless module. The low power consumption wireless module is coupled to the main system and the control circuit. The main system includes a storage media and a processor. The processor is coupled to the storage media. The storage media stores a user list. The processor turns on the low power consumption wireless module and transmits a beacon packet to the low power consumption wireless module in response to receiving a sleep request in a working mode. The low power consumption wireless module turns off a power of the main system through the control circuit in response to receiving the beacon packet to allow the wireless access point to enter a sleep mode. The low power consumption wireless module sends the beacon packet during the sleep mode. The low power consumption wireless module turns on the power through the control circuit in response to receiving a probe request to allow the wireless access point to return to the working mode.

The disclosure also provides an energy saving control method adapted for a wireless access point. The wireless access point includes a main system and a low power consumption wireless module. The main system includes a processor, a storage media, and multiple functional members. The storage media stores a user list. The energy saving control method includes: the low power consumption wireless module is turned on by the processor, and a beacon packet is transmitted to the low power consumption wireless module in response to receiving a sleep request in a working mode; the functional members are turned off by the low power consumption wireless module in response to receiving the beacon packet to allow the wireless access point to enter a sleep mode; the beacon packet is sent by the low power consumption wireless module during the sleep mode; and the functional members are turned on by the low power consumption wireless module in response to receiving a probe request to allow the wireless access point to return to the working mode.

The disclosure also provides an energy saving control method adapted for a wireless access point. The wireless access point includes a main system, a control circuit, and a low power consumption wireless module. The main system includes a processor and a storage media. The storage media stores a user list. The energy saving control method includes: the low power consumption wireless module is turned on by the processor, and a beacon packet is transmitted to the low power consumption wireless module in response to receiving a sleep request in a working mode; a power of the main system is turned off through the control circuit by the low power consumption wireless module in response to receiving the beacon packet to allow the wireless access point to enter a sleep mode; the beacon packet is sent by the low power consumption wireless module during the sleep mode; and the power is turned on through the control circuit by the low power consumption wireless module in response to receiving a probe request to allow the wireless access point to return to the working mode.

Based on the above, the wireless access point and the energy saving control method thereof according to the disclosure provides a simple sleep and wake-up process, which can turn off (or turn on) some functional members of the main system or the power of the main system based on a sleep request (or a probe request), thereby significantly enhancing the energy saving effect of the wireless access point. An operation of the main system is simulated through the low power consumption wireless module during the sleep mode to maintain a normal operation of the network.

### BRIEF DESCRIPTION OF THE DRAWINGS

FIG. 1 is a schematic diagram of a wireless access point and an electronic device according to an embodiment of the disclosure.

FIG. 2 is a flow chart of an energy saving control method adapted for a wireless access point according to an embodiment of the disclosure.

FIG. 3 is a flow chart of an energy saving control method adapted for a wireless access point according to an embodiment of the disclosure.

### DESCRIPTION OF THE EMBODIMENTS

Some embodiments of the disclosure will be described in detail with reference to the drawings. When the same reference numerals appear in different drawings, they will be regarded as the same or similar elements. The embodiments are only a part of the disclosure and do not disclose all possible implementations of the disclosure. More precisely, the embodiments are merely examples of the claims of the disclosure.

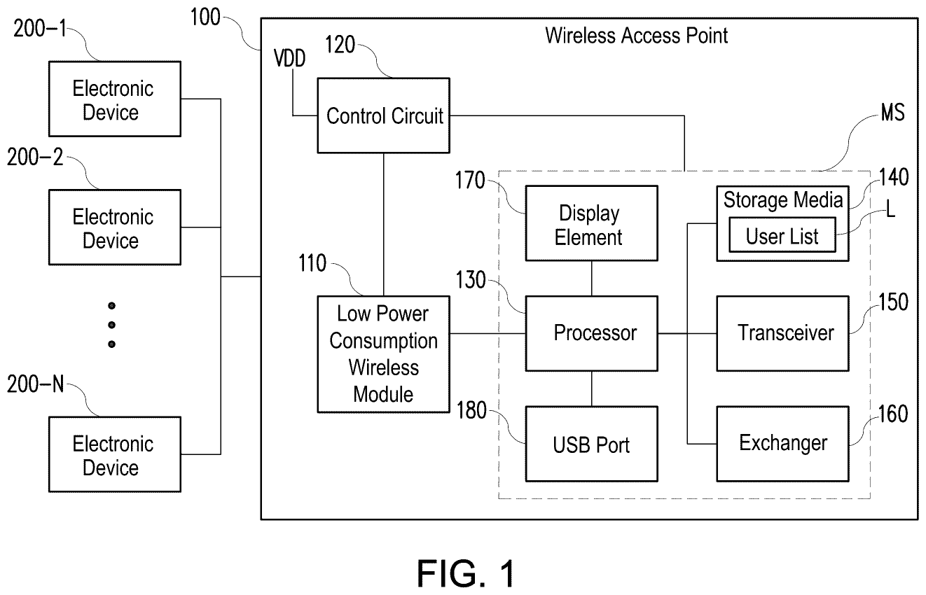

FIG. 1 is a schematic diagram of a wireless access point and an electronic device according to an embodiment of the disclosure. Please refer to FIG. 1. In the embodiment, a wireless access point 100 may be, for example, a Wi-Fi access point (Wi-Fi AP), a wireless router, or other equipment with an access point (AP) function. Electronic devices 200-1 to 200-N may be, for example, smartphones, desktop computers, laptops, wearable devices, or other devices with a station (STA) function. The electronic devices 200-1 to 200-N may be connected to the wireless access point 100 to access the Internet and/or local network. Specifically, the wireless access point 100 is connected to the electronic devices 200-1 to 200-N and provides a wireless access service for the electronic devices 200-1 to 200-N. The wireless access service may include but is not limited to an establishment procedure of wireless connection, a maintenance procedure of wireless connection, a release procedure of wireless connection, a registration procedure, an identity authentication procedure, a transmission procedure of data packet and/or signal, etc.

The wireless access point 100 includes a main system MS, a low power consumption wireless module 110, and a control circuit 120. The low power consumption wireless module 110 is coupled to the main system MS and the control circuit 120. The main system MS may include a processor 130, a storage media 140, and multiple functional members. In an embodiment, the multiple functional members may include but are not limited to a transceiver 150, an exchanger 160, a display element 170, and a USB port 180.

The low power consumption wireless module 110 is, for example, a Wi-Fi wireless module. In the embodiment, when the wireless access point 100 is in a working mode, the low power consumption wireless module 110 may be turned off. Conversely, when the wireless access point 100 is in a sleep mode, the low power consumption wireless module 110 may be turned on to simulate an operation of the wireless access point 100.

The control circuit 120 is, for example, an over voltage protection (OVP) circuit or a power switching circuit well known to those skilled in the art. In the embodiment, the control circuit 120 is, for example, connected to a system power VDD and configured to control a connection status between the system power VDD and the low power consumption wireless module 110 and the main system MS.

The processor 130 is, for example, a central processing unit (CPU), a micro control unit (MCU), a microprocessor, a digital signal processor (DSP), a programmable controller, a field programmable gate array (FPGA), or other similar elements or a combination of the foregoing elements. The processor 130 may also be, for example, a system on a chip (SoC).

The storage media 140 is, for example, a random access memory (RAM), a flash memory, a hard disk drive (HDD), a solid state drive (SSD), or similar elements or a combination of the foregoing elements. The storage media 140 stores, for example, a user list and other commands and/or data that may be accessed and executed by the processor 130. In an embodiment, a user list L includes, for example, a media access control (MAC) address of the electronic devices 200-1 to 200-N that may connect with the wireless access point 100.

For example, if an electronic device (such as the electronic device 200-N) that may connect with the wireless access point 100 is to be added, the user needs to perform a registration procedure with the wireless access point 100 through the electronic device 200-N when the wireless access point 100 is in a working mode. Afterwards, after the registration procedure is successfully completed, the processor 130 may record a MAC address of the electronic device 200-N in the user list L.

The transceiver 150 is, for example, various communication chips, mobile communication chips, Bluetooth chips, Wi-Fi chips, radio frequency (RF) chips, etc., but is not limited thereto.

The display element 170 is, for example, a light-emitting diode (LED), a liquid-crystal display (LCD), or other similar elements having a display function or a light-emitting function.

In an embodiment, when the electronic devices 200-1 to 200-N are to establish connection with the wireless access point 100, the electronic devices 200-1 to 200-N may send a probe request to initiate a request of establishing connection to the wireless access point 100. Alternatively, the electronic devices 200-1 to 200-N may also receive a beacon packet from the wireless access point 100 to obtain related information of the wireless access point 100, and send the probe request accordingly to establish connection with the wireless access point 100.

In an embodiment, in a working mode, if the wireless access point 100 does not establish connection with any equipment after a preset time, the wireless access point 100 may enter a sleep mode. The preset time may be designed according to actual needs, and is not limited by the disclosure. In another embodiment, the wireless access point 100 may enter the sleep mode according to other conditions, and is not limited by the disclosure.

In an embodiment, in a working mode, an equipment (such as the electronic device 200-1) that connects with the wireless access point 100 may send a sleep request to the wireless access point 100 to indicate (or schedule) the wireless access point 100 to enter a sleep mode.

Specifically, when the wireless access point 100 (the transceiver 150) receives the sleep request, the processor 130 may turn on the low power consumption wireless module 110, and transmit a beacon packet to the low power consumption wireless module 110. Furthermore, when the wireless access point 100 is in the sleep mode, the low power consumption wireless module 110 may be configured to simulate an operation of sending the beacon packet of the wireless access point 100 to establish connection with the electronic devices 200-1 to 200-N. Therefore, after the wireless access point 100 receives the sleep request, the processor 130 needs to first transmit the beacon packet to the low power consumption wireless module 110 to allow the low power consumption wireless module 110 to successfully simulate the operation of the wireless access point 100 during the subsequent sleep mode.

In an embodiment, when the low power consumption wireless module 110 receives a beacon packet, the low power consumption wireless module 110 may turn off the multiple functional members of the main system MS to allow the wireless access point 100 to enter a sleep mode. Specifically, after the low power consumption wireless module 110 successfully simulates the beacon packet received from the main system MS, the low power consumption wireless module 110 may, for example, send a control command (also called, a first control command) to the main system MS, to indicate the processor 130 to turn off power-consuming elements in the main system MS (such as the exchanger 160, the display element 170 and/or the USB port 180) to allow the wireless access point 100 to formally enter the sleep mode. At this time, the wireless access point 100 is in the sleep mode under a first level energy saving status. In an embodiment, when the low power consumption wireless module 110 receives a beacon packet, the low power consumption wireless module 110 may turn off a power of the main system MS through the control circuit 120 to allow the wireless access point 100 to enter a sleep mode. Specifically, after the low power consumption wireless module 110 successfully simulates the beacon packet received from the main system MS, the low power consumption wireless module 110 may, for example, send a control command (also called, a second control command) to the control circuit 120 to indicate the control circuit 120 to cut off the power of the main system MS (such as cutting off a transmission path between the main system MS and the system power VDD) to completely turn off the main system MS to allow the wireless access point 100 to formally enter the sleep mode. At this time, the wireless access point 100 is in the sleep mode under a second level energy saving status.

In other words, the user may, for example, send a sleep request configured to indicate entering the sleep mode under the first level energy saving status (or a sleep request configured to indicate entering the sleep mode under the second level energy saving status) to the wireless access point 100 through an equipment that connects to the wireless access point 100 (that is, the electronic device 200-1) to indicate (or schedule) the wireless access point 100 to enter the corresponding sleep mode. It is worth mentioning that the energy saving effect of the sleep mode under the second level energy saving status is superior to the energy saving effect of the sleep mode under the first level energy saving status.

Afterwards, during the sleep mode, the low power consumption wireless module 110 may, for example, continuously (or periodically) send the beacon packet to simulate the operation of the main system MS.

Next, when an equipment that matches the user list L (that is, an equipment whose MAC address has been recorded in the user list L) is to establish connection with the wireless access point 100 that is in the sleep mode, the equipment (such as the electronic device 200-2) may proactively send a probe request to establish connection with the wireless access point 100. In an embodiment, assuming a STA function of the electronic device 200-2 has been turned on, the beacon packet from the low power consumption wireless module 110 may be passively received, determining that the electronic device 200-2 is located within a service range of the wireless access point 100, and sends a probe request to establish connection with the wireless access point 100. In an embodiment, assuming the electronic device 200-2 is located within the service range of the wireless access point 100, but the STA function of the electronic device 200-2 has not been turned on, the user may, for example, turn on the STA function to allow the electronic device 200-2 to proactively send the probe request to establish connection with the wireless access point 100.

Accordingly, when the low power consumption wireless module 110 receives the probe request from the electronic device 200-2, the low power consumption wireless module 110 may allow the wireless access point 100 to return to a working mode to establish connection with the electronic device 200-2. In an embodiment, when a probe request from the electronic device 200-2 is received, the low power consumption wireless module 110 may, for example, send a control command (also called, a third control command) to the main system MS to indicate the processor 130 to turn on the power-consuming elements that have been turned off in the main system MS (such as the exchanger 160, the display element 170 and/or the USB port 180) to allow the wireless access point 100 to return to the working mode, thereby establishing connection with the electronic device 200-2. In an embodiment, when a probe request from the electronic device 200-2 is received, the low power consumption wireless module 110 may, for example, send a control command (also called, a fourth control command) to the control circuit 120 to indicate the control circuit 120 to turn on a power of the main system MS (that is, turn on a transmission path between the main system MS and the system power VDD) to wake up the main system MS to allow the wireless access point 100 to return to the working mode, thereby establishing connection with the electronic device 200-2.

It should be noted that when the wireless access point 100 returns to the working mode, the low power consumption wireless module 110 configured to simulate the operation of the main system MS does not need to be used, so the low power consumption wireless module 110 may be turned off by the main system MS (the processor 130) or turned off on its own.

Based on the above, the electronic devices 200-1 to 200-N may send the sleep request to indicate (or schedule) the wireless access point 100 to enter the sleep mode. Afterwards, the low power consumption wireless module 110 may simulate the operation of the main system MS, and when the probe request from the electronic devices 200-1 to 200-N is received, the wireless access point 100 is woken up. In addition, the low power consumption wireless module 110 of the disclosure may further complete the sleep mode under the first level power saving status and the sleep mode under the second level power saving status in conjunction with the control circuit 120, effectively enhancing the energy saving effect of the wireless access point 100.

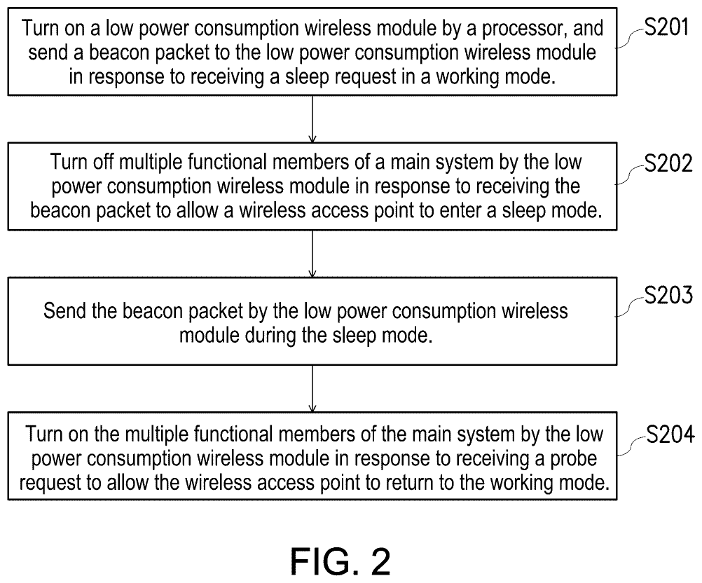

FIG. 2 is a flow chart of an energy saving control method of a wireless access point according to an embodiment of the disclosure. The energy saving control method may be implemented by the wireless access point 100 as shown in FIG. 1. Please refer to FIG. 1 and FIG. 2. In step S201, the low power consumption wireless module 110 is turned on by the processor 130, and a beacon packet is transmitted to the low power consumption wireless module 110 in response to receiving a sleep request in a working mode. In step S202, multiple functional members of the main system MS are turned off by the low power consumption wireless module 110 in response to receiving the beacon packet to allow the wireless access point 100 to enter a sleep mode. In step S203, the beacon packet is sent by the low power consumption wireless module 110 during the sleep mode. In step S204, the multiple functional members of the main system MS are turned on by the low power consumption wireless module 110 in response to receiving a probe request to allow the wireless access point 100 to return to the working mode.

The implementation details of steps S201 to S204 have been clearly described in the foregoing multiple embodiments. Therefore, the same details will not be repeated herein.

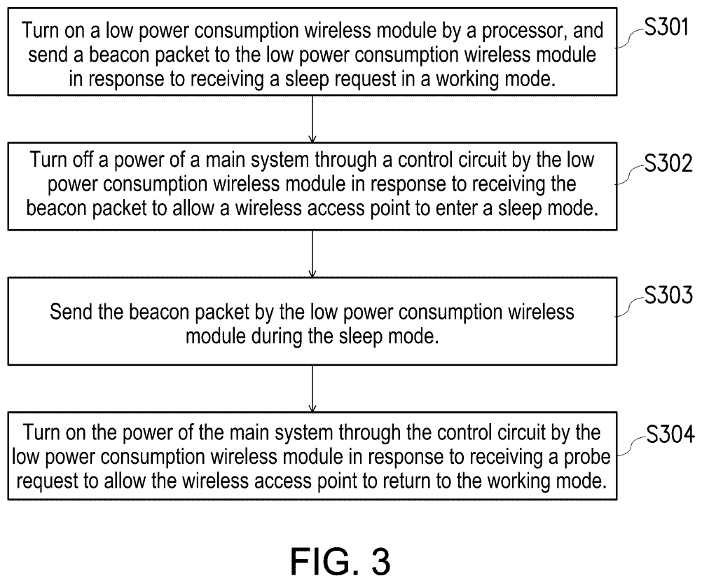

FIG. 3 is a flow chart of an energy saving control method of a wireless access point according to an embodiment of the disclosure. The energy saving control method may be implemented by the wireless access point 100 as shown in FIG. 1. Please refer to FIG. 1 and FIG. 3. In step S301, the low power consumption wireless module 110 is turned on by the processor 130, and a beacon packet is transmitted to the low power consumption wireless module 110 in response to receiving a sleep request in a working mode. In step S302, a power of the main system MS is turned off through the control circuit 120 by the low power consumption wireless module 110 in response to receiving the beacon packet to allow the wireless access point 100 to enter a sleep mode. In step S303, the beacon packet is sent by the low power consumption wireless module 110 during the sleep mode. In step S304, the power of the main system MS is turned on through the control circuit 120 by the low power consumption wireless module 110 in response to receiving a probe request to allow the wireless access point 100 to return to the working mode.

The implementation details of steps S301 to S304 have been clearly described in the foregoing multiple embodiments. Therefore, the same details will not be repeated herein.

In summary, the wireless access point and the energy saving control method thereof provided by the embodiments of the disclosure may allow the wireless access point to sleep or wake up the wireless access point through a simple manner of sending packets (that is, a sleep request and a probe request), and simulate the operation of the main system (that is, transmitting a beacon packet) through the low power consumption wireless module during a sleep mode to allow the main system to enter a more complete sleep mode (such as directly turning off the power of the main system), thereby significantly enhancing the energy saving effect of the wireless access point.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A wireless access point, comprising:
a main system, comprising:
a storage media, storing a user list;
a processor, coupled to the storage media; and
a plurality of functional members, electrically connected to the processor; and
a low power consumption wireless module, coupled to the main system, wherein
the processor turns on the low power consumption wireless module, and transmits a beacon packet to the low power consumption wireless module in response to receiving a sleep request in a w orking mode,
the low power consumption wireless module turns off the functional members in response to receiving the beacon packet to allow the wireless access point to enter a sleep mode,
the low power consumption wireless module sends the beacon packet during the sleep mode,
the low power consumption wireless module turns on the functional members in response to receiving a probe request to allow the wireless access point to return to the working mode.

2. The wireless access point according to claim 1, wherein the user list comprises at least one media access control (MAC) address of at least one electronic device that may connect to the wireless access point.

3. A wireless access point, comprising:
a main system, comprising:
a storage media, storing a user list; and
a processor, coupled to the storage media;
a control circuit; and
a low power consumption wireless module, coupled to the main system and the control circuit, wherein
the processor turns on the low power consumption wireless module, and transmits a beacon packet to the low power consumption wireless module in response to receiving a sleep request in a working mode,
the low power consumption wireless module turns off a power of the main system through the control circuit in response to receiving the beacon packet to allow the wireless access point to enter a sleep mode,
the low power consumption wireless module sends the beacon packet during the sleep mode, and
the low power consumption wireless module turns on the power through the control circuit in response to receiving a probe request to allow the wireless access point to return to the working mode.

4. The wireless access point according to claim 3, wherein the user list comprises at least one media access control address of at least one electronic device that may perform connection with the wireless access point.

5. The wireless access point according to claim 3, wherein the control circuit is an over voltage protection (OVP) circuit.

6. An energy saving control method, adapted for a wireless access point, wherein the wireless access point comprises a main system and a low power consumption wireless module, the main system comprises a processor, a storage media and a plurality of functional members, the storage media stores a user list, and the energy saving control method comprises:
turning on the low power consumption wireless module by the processor, and transmitting a beacon packet to the low power consumption wireless module in response to receiving a sleep request in a working mode;
turning off the functional members by the low power consumption wireless module in response to receiving the beacon packet to allow the wireless access point to enter a sleep mode;
sending the beacon packet by the low power consumption wireless module during the sleep mode; and
turning on the functional members by the low power consumption wireless module in response to receiving a probe request to allow the wireless access point to return to the working mode.

7. The energy saving control method according to claim 6, wherein the user list comprises at least one media access control address of at least one electronic device that may connect to the wireless access point.

8. An energy saving control method, adapted for a wireless access point, wherein the wireless access point comprises a main system, a control circuit and a low power consumption wireless module, the main system comprises a processor and a storage media, the storage media stores a user list, and the energy saving control method comprises:
turning on the low power consumption wireless module by the processor, and transmitting a beacon packet to the low power consumption wireless module in response to receiving a sleep request in a working mode;
turning off a power of the main system through the control circuit by the low power consumption wireless module in response to receiving the beacon packet to allow the wireless access point to enter a sleep mode;
sending the beacon packet by the low power consumption wireless module during the sleep mode; and
turning on the power through the control circuit by the low power consumption wireless module in response to receiving a probe request to allow the wireless access point to return to the working mode.

9. The energy saving control method according to claim 8, wherein the user list comprises at least one media access control address of at least one electronic device that may connect to the wireless access point.

10. The energy saving control method according to claim 8, wherein the control circuit is an over voltage protection circuit.
